(19) United States
(12) Patent Application Publication
(10) Pub. No.: US 2013/0336532 A1
(43) Pub. Date: Dec. 19, 2013

(54) INFORMATION PROCESSING APPARATUS, INFORMATION PROCESSING METHOD, AND PROGRAM PRODUCT

(71) Applicant: Kabushiki Kaisha Toshiba, Tokyo (JP)

(72) Inventors: Yasuyuki TANAKA, Akishima-shi (JP); Akira TANAKA, Mitaka-shi (JP); Ryuji SAKAI, Hanno-shi (JP); Kosuke HARUKI, Tachikawa-shi (JP); Mitsuru SHIMBAYASHI, Nakano-ku (JP); Takahiro SUZUKI, Hamura-shi (JP)

(73) Assignee: Kabushiki Kaisha Toshiba, Tokyo (JP)

(21) Appl. No.: 13/970,359

(22) Filed: Aug. 19, 2013

Related U.S. Application Data
(63) Continuation of application No. PCT/JP2013/058195, filed on Mar. 14, 2013.

(30) Foreign Application Priority Data
May 23, 2012 (JP) 2012-117942

(51) Int. Cl. G06K 9/00

(52) U.S. Cl. CPC G06K 9/00335
USPC 382/103

(57) ABSTRACT

According to one embodiment, an information processing apparatus includes: a detector configured to set a plurality of detection areas to a single piece of face image included in a video image that is based on input video data, with reference to a position of the face image to detect movements of an operator giving an operation instruction in the detection areas; and an output module configured to output operation data indicating the operation instruction based on a combination of the movements detected in the detection areas.

### CROSS-REFERENCE TO RELATED APPLICATIONS

This application is a continuation of PCT international application Ser. No. PCT/JP2013/058195, filed on Mar. 14, 2013, which designates the United States, incorporated herein by reference, and which is based upon and claims the benefit of priority from Japanese Patent Application No. 2012-117942, filed on May 23, 2012, the entire contents of which are incorporated herein by reference.

### FIELD

Embodiments described herein relate generally to an information processing apparatus, an information processing method, and a program product.

### BACKGROUND

Known is an information processing apparatus that detects an operator movement for an operation instruction from a video that is based on video data captured by an image capturing apparatus, and outputs operation data indicating the operation instruction given by the movement thus detected to a target apparatus.

However, according to the conventional technology, the operator cannot recognize the area where a movement of the operator giving an operation instruction is detected in the video that is based on the video data captured by the image capturing apparatus. Therefore, an operator movement other than an operation instruction might be detected as an operator movement giving an operation instruction, and the accuracy at which the target apparatus is caused to operate via a gesture is low. In addition, it has been desired to increase the number of operation instructions to be given via movements that are detected from the area where an operator movement giving an operation instruction is detected.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external view of a computer according to an embodiment;

FIG. 2 is an exemplary block diagram generally illustrating a configuration of the computer in the embodiment;

FIG. 3 is an exemplary block diagram illustrating a part of a functional configuration of the computer in the embodiment;

FIG. 4 is an exemplary flowchart illustrating a process of outputting operation data in the computer in the embodiment;

FIG. 5 is an exemplary schematic diagram for explaining a process of setting a detection area in the computer in the embodiment;

FIG. 6 is an exemplary schematic diagram for explaining the process of setting a detection area in the computer in the embodiment;

FIG. 7 is an exemplary schematic diagram for explaining the process of setting a detection area in the computer in the embodiment;

FIG. 8 is an exemplary schematic diagram for illustrating a process of setting a detection area in the computer in the embodiment;

FIG. 9 is an exemplary schematic diagram for illustrating a process of detecting a movement of an operation instruction in the computer in the embodiment;

FIG. 10 is an exemplary schematic diagram for explaining the process of detecting a movement of an operation instruction in the computer in the embodiment;

FIGS. 11A to 11D are exemplary schematic diagrams for explaining a process of outputting operation data in the computer in the embodiment; and

FIGS. 12A to 12D are exemplary schematic diagrams for explaining the process of outputting operation data in the computer in the embodiment.

### DETAILED DESCRIPTION

In general, according to one embodiment, an information processing apparatus comprises: a detector configured to set a plurality of detection areas to a single piece of face image included in a video image that is based, on input video data, with reference to a position of the face image to detect movements of an operator giving an operation instruction in the detection areas; and an output module configured to output operation data indicating the operation instruction based on a combination of the movements detected in the detection areas.

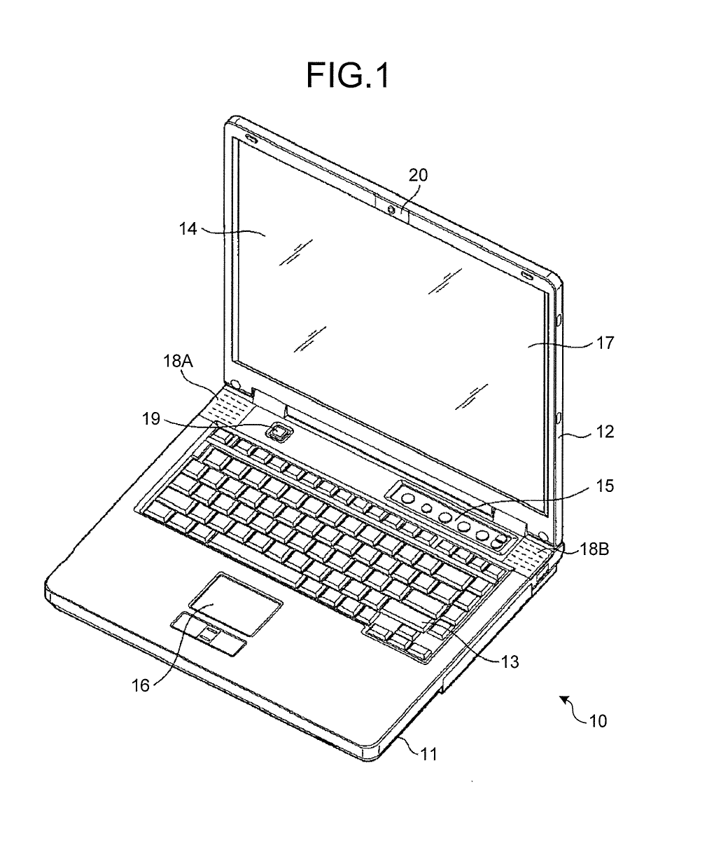

FIG. 1 is an external view of a computer according to an embodiment. Explained in the embodiment is an example in which an information processing apparatus, an information processing method, and a computer program are applied to a laptop personal computer (hereinafter referred to as a computer) 10, but the embodiment is not limited thereto, and is also applicable to a remote controller, a television receiver, a hard disk recorder, or the like. As illustrated in FIG. 1, the computer 10 according to the embodiment comprises a main unit 11 and a display unit 12. The display unit 12 is provided with a display device with a liquid crystal display (LCD) 17. The display unit 12 is also provided with a touch panel 14 covering the surface of the LCD 17. The display unit 12 is attached to the main unit 11 movably between an opened position exposing the top surface of the main unit 11 and a closed position covering the top surface of the main unit 11. The display unit 12 comprises a camera module 20 located at the top of the LCD 17. The camera module 20 is used to capture the image of an operator or the like of the computer 10 when the display unit 12 is at the opened position where the top surface of the main unit 11 is exposed.

The main unit 11 comprises a housing in a shape of a thin box. On the top surface of the main unit 11, a keyboard 13, an input operation panel 15, a touch pad 16, speakers 18A and 18B, and a power button 19 for powering on and off the computer 10, and the like are provided. On the input operation panel 15, various operation buttons are provided.

On the rear surface of the main unit 11, a terminal for connecting an external display (not illustrated), such as a terminal based on the High-Definition Multimedia Interface (HDMI) standard, is provided. The terminal for connecting an external display is used to output a digital video signal to the external display.

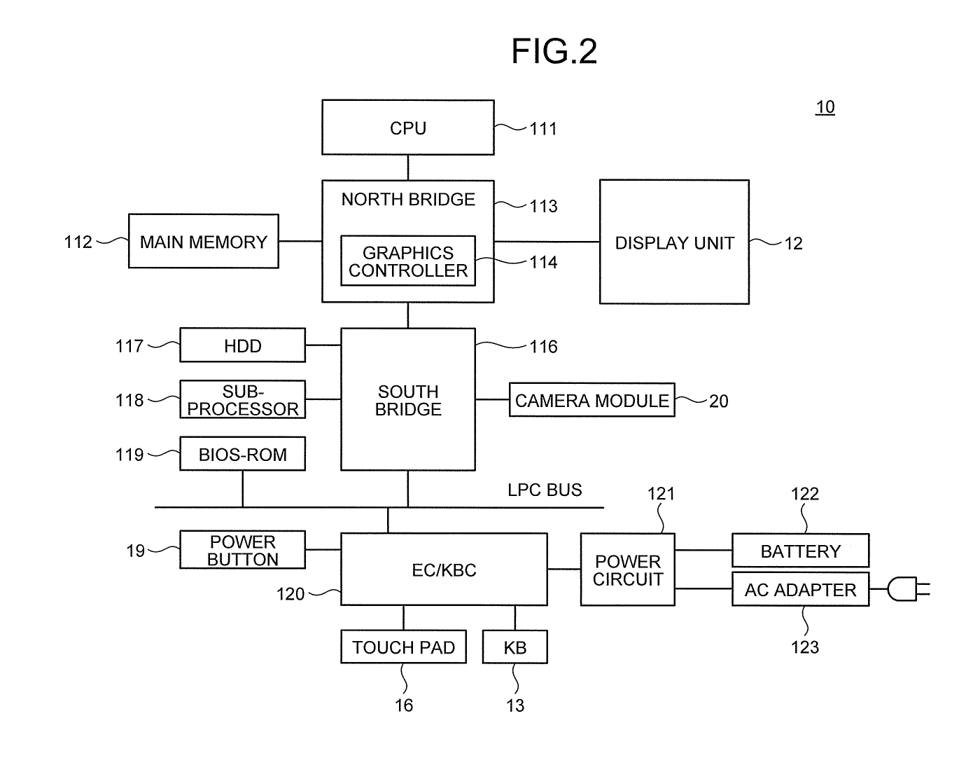

FIG. 2 is a block diagram generally illustrating a configuration of the computer in the embodiment. The computer 10 according to the embodiment comprises a central processing unit (CPU) 111, a main memory 112, a north bridge 113, a graphics controller 114, the display unit 12, a south bridge 116, a hard disk drive (HDD) 117, a sub-processor 118, a basic input/output system read-only memory (BIOS-ROM) 119, an embedded controller/keyboard controller (EC/KBC) 120, a power circuit 121, a battery 122, an alternating current (AC) adapter 123, the touch pad 16, the keyboard (KB) 13, the camera module 20, and the power button 19.

The CPU 111 is a processor for controlling operations of the computer 10. The CPU 111 executes an operating system (OS) and various types of application programs loaded onto the main memory 112 from the HDD 117. The CPU 111 also executes a basic input/output system (BIOS) stored in the BIOS-ROM 119. The BIOS is a computer program for controlling peripheral devices. The BIOS is executed to begin with when the computer 10 is powered on.

The north bridge 113 is abridge device for connecting a local bus of the CPU 111 and the south bridge 116. The north bridge 113 has a function of communicating with the graphics controller 114 via an accelerated graphics port (AGP) bus or the like.

The graphics controller 114 is a display controller for controlling the display unit 12 of the computer 10. The graphics controller 114 generates video signals to be output to the display unit 12 from image data written by the OS or an application program to a video random access memory (VRAM) (not illustrated).

The HDD 117, the sub-processor 118, the BIOS-ROM 119, the camera module 20, and the EC/KBC 120 are connected to the south bridge 116. The south bridge 116 comprises an integrated drive electronics (IDE) controller for controlling the HDD 117 and the sub-processor 118.

The EC/KBC 120 is a single-chip microcomputer in which an embedded controller (EC) for managing power and a keyboard controller (KBC) for controlling the touch pad 16 and the KB 13 are integrated. The EC/KBC 120 works with the power circuit 121 to power on the computer 10 when the power button 19 is operated, for example. When an external power is supplied via the AC adapter 123, the computer 10 is powered by the external power. When no external power is supplied, the computer 10 is powered by the battery 122.

The camera module 20 is a universal serial bus (USB) camera, for example. The USB connector on the camera module 20 is connected to an USB port (not illustrated) provided on the main unit 11 of the computer 10. Video data (image data) captured by the camera module 20 is stored in the main memory 112 or the like as frame data, and can be displayed on the display unit 12. The frame rate of frame images included in the video data captured by the camera module 20 is 15 frames/second, for example. The camera module 20 may be an external camera, or may be a built-in camera in the computer 10.

The sub-processor 118 processes video data acquired from the camera module 20, for example.

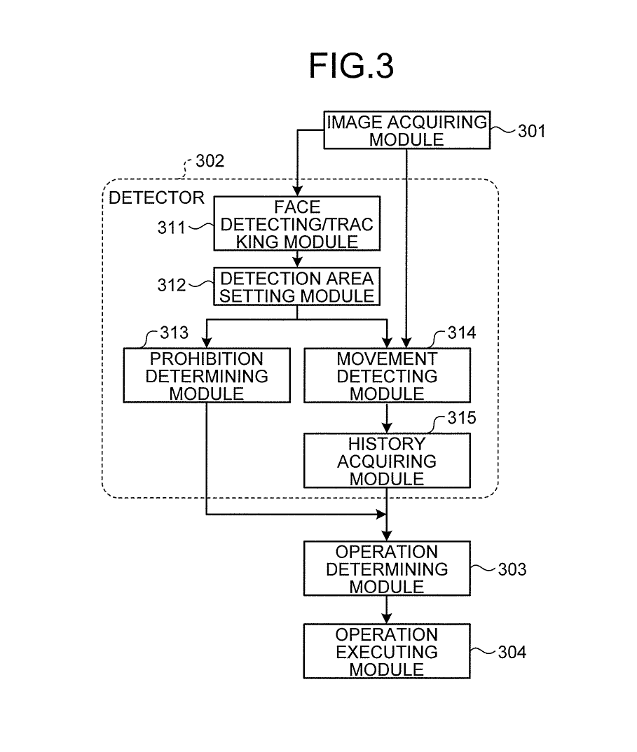

FIG. 3 is a block diagram illustrating a part of a functional configuration of the computer in the embodiment. The computer 10 according to the embodiment realizes an image acquiring module 301, a detector 302, an operation determining module 303, an operation executing module 304, and the like by causing the CPU 111 to execute the OS and the application programs stored in the main memory 112.

The image acquiring module 301 acquires video data captured by the camera module 20, and stores the video data in the HDD 117, for example.

The detector 302 sets a plurality of detection areas to a single face image included in a video that is based on the input video data (video data acquired by the image acquiring module 301), with reference to the position of the face image. The detector 302 then detects movements of an operator of the computer 10 giving an operation instruction from the respective detection areas. In the embodiment, the detector 302 comprises a face detecting/tracking module 311, a detection area setting module 312, a prohibition determining module 313, a movement detecting module 314, and a history acquiring module 315.

The operation determining module 303 functions as an output module that outputs operation data indicating an operation instruction given by a combination of the movements detected by the detector 302 in the detection areas. The operation executing module 304 controls a target apparatus (e.g., the display unit 12, the speakers 18A and 18B, or the external display) based on the operation data output from the operation determining module 303.

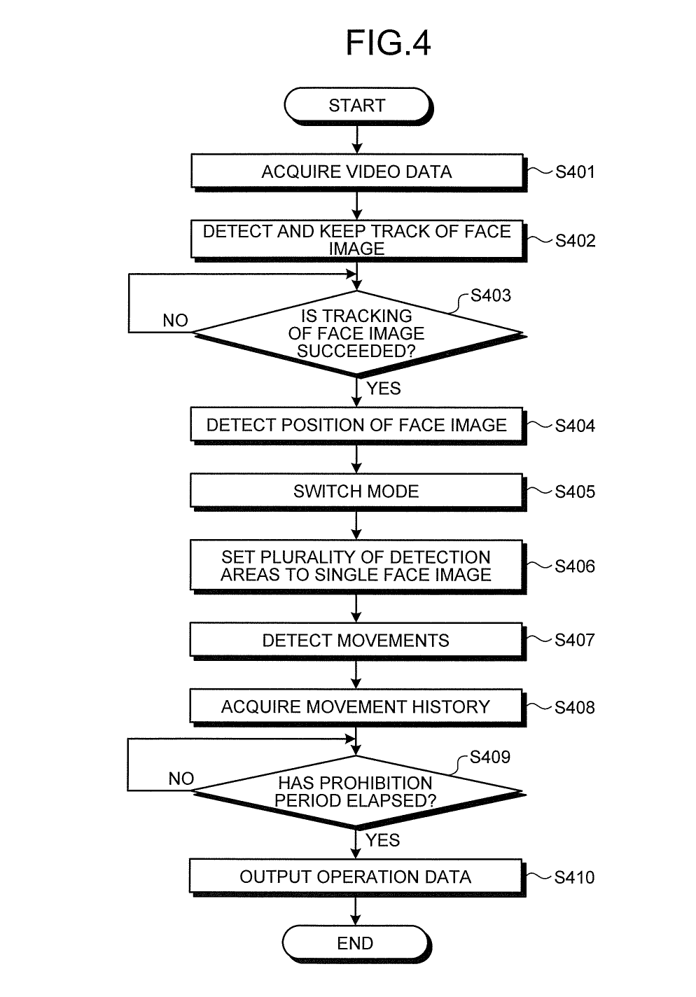

A process of outputting the operation data in the computer 10 according to the embodiment will now be explained with reference to FIGS. 4 to 12. FIG. 4 is a flowchart illustrating a process of outputting operation data in the computer in the embodiment.

While the computer 10 is on after the power button 19 is operated, the image acquiring module 301 acquires video data captured by the camera module 20 (S401). In the embodiment, the image acquiring module 301 acquires video data by sampling a frame image at a preset sampling rate from frame images captured at a given frame rate by the camera module 20. In other words, the image acquiring module 301 keeps sampling frame images to acquire video data. The video data thus acquired may include a face image of an operator of the computer 10 (hereinafter referred to as a face image).

Once the image acquiring module 301 acquires the video data, the face detecting/tracking module 311 detects a face image from the video that is based on the video data thus acquired, and keeps track of the face image (S402). Keeping track of a keeping sampling frame images face image herein means to keep detecting a face image of the same operator across the frame images included in the acquired video data.

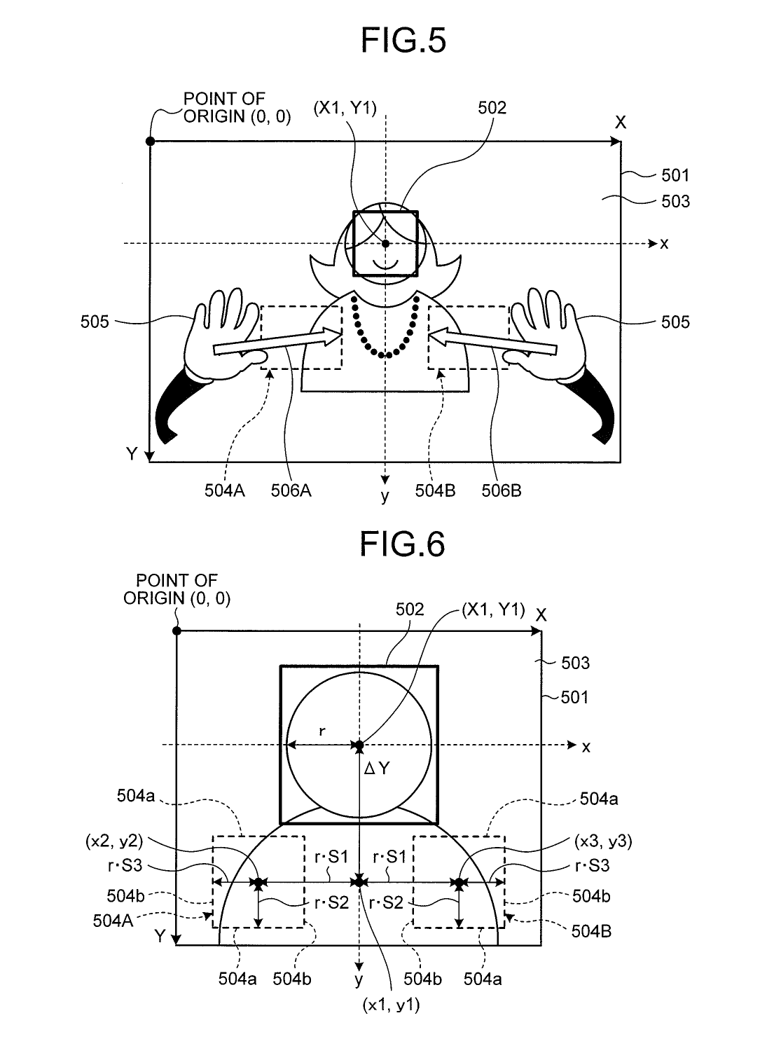

Specifically, the face detecting/tracking module 311 distinguishes a face image 502 from a non-face image 503 in a frame image 501 included in the video that is based on the acquired video data, using Scale-Invariant Feature Transform (SIFT), Speeded Up Robust Features (SURF), or the like, as illustrated in FIG. 5. In this manner, the face detecting/tracking module 311 detects the face image 502.

The face detecting/tracking module 311 then detects a plurality of characterizing points (e.g., three points of the nose, the left eye, and the right eye) from the face image 502 in the frame image 501 included in the video that is based on the acquired video data, using simultaneous localization and mapping (SLAM) (an example of parallel tracking and mapping (PTAM)) or the like that uses a tracking technique for keeping track of characterizing points, such as the Kanade Lucas Tomasi (KLT). At this time, the face detecting/tracking module 311 detects characterizing points that are the same as those in the face image 502 included in a frame image captured prior to the frame image 501, among the characterizing points in the face image 502 included in the frame image 501. In this manner, the face detecting/tracking module 311 keeps track of the detected face image 502.

The face detecting/tracking module 311 detects the face image 502 of a face directly facing the camera module 20, from the face images included in the frame image 501 included in the video that is based on the acquired video data. In the embodiment, the face detecting/tracking module 311 detects a face image including both eyes, or a face image not including ears as a face image 502 of a face directly facing the front, among the face images included in the frame image 501 included in the video that is based on the acquired video data. In other words, it can be assumed that, when an operator intends to make operations on the computer 10, the operator directly faces the display unit 12. Therefore, by detecting a face image 502 of a face directly facing the camera module 20, the face detecting/tracking module 311 can detect only the face image 502 of an operator intended to make operations on the computer 10. Because the subsequent process is triggered when an operator faces the display unit 12 directly, extra operations required for making an operation instruction via a gesture can be omitted.

Referring back to FIG. 4, the detection area setting module 312 determines if the face detecting/tracking module 311 succeeds in keeping track of the face image (S403). If the face detecting/tracking module 311 keeps track of the face image for given time (in the embodiment, equal to less than 1 second), the detection area setting module 312 determines that the face detecting/tracking module 311 succeeds in keeping track of the face image. If the face detecting/tracking module 311 fails to keep track of the face image (No at S403), the detection area setting module 312 waits until the face detecting/tracking module 311 succeeds in keeping track of a face image.

If the face detecting/tracking module 311 succeeds in keeping track of the face image (Yes at S403), the detection area setting module 312 detects the position of the face image included in the video that is based on the acquired video data (S404). In the embodiment, as the position of the face image 502, the detection area setting module 312 detects position coordinates (X1, Y1) of the center of the face image 502 detected by the face detecting/tracking module 311 (the position of the nose, in the embodiment) in a preset coordinate system having a point of origin (0, 0) at the upper left corner of the frame image 501 included in the video data (hereinafter referred to as an XY coordinate system), as illustrated in FIG. 5. When a plurality of face images are included in the video based on the acquired video data, the detection area setting module 312 detects respective positions of the face images. If the position of the face image detected by the face detecting/tracking module 311 moves by a given distance or more within given time, the computer 10 stops the process of outputting the operation data. In this manner, when the operator loses his/her intention of making operations on the computer 10 and the position of the face image suddenly changes, e.g., when the operator stands up or lies down, the computer 10 can stop outputting the operation data.

The detection area setting module 312 detects an inclination of the axis that extends in the vertical direction of the face image (hereinafter, referred to as a face image axis) (an example of a first axis) in the video that is based on the acquired video data. In the embodiment, the face image axis passes through the center (position coordinates (X1, Y1) of the face image. The detection area setting module 312 then detects an inclination of the face image axis (angle θ) in the XY coordinate system as an inclination of the face image. Alternatively, the detection area setting module 312 may consider an axis extending in the vertical direction of the face image and passing through the axis of symmetry that makes the face image symmetric as the face image axis, and detect the inclination of the face image axis in the XY coordinate system as an inclination of the face image. As another alternative, in a triangle connecting the nose, the left eye, and the right eye detected as the characterizing points of the face image, the detection area setting module 312 may consider a perpendicular drawn from the characterizing point at the nose to a line segment connecting the characterizing points at the left eye and at the right eye as a face image axis, and detect the inclination of the face image axis in the XY coordinate system as an inclination of the face image.

Referring back to FIG. 4, the detection area setting module 312 is switched to one of a first mode and a second mode depending on the image data displayed on the display unit 12 (S405). The first mode is for detecting an operator movement for an operation instruction with reference to the XY coordinate system, and the second mode is for detecting an operator movement for an operation instruction with reference to a coordinate system using the face image axis as a coordinate axis (hereinafter, referred to as an xy coordinate system). The xy coordinate system is a coordinate system in which the axis of the face image 502 is used as a y axis and an axis perpendicularly intersecting with the y axis is used as an x axis (an example of a second axis). In the embodiment, the xy coordinate system is a coordinate system in which the axis of the face image 502 is used as a y axis and an axis perpendicularly intersecting with the y axis at the center of the face image 502 (position coordinates (X1, Y1)) is used as an x axis.

In the embodiment, if the image data displayed on the display unit 12 allows an operator to make an operation instruction more easily when the display unit 12 is used as a reference, the detection area setting module 312 is switched to the first mode. Examples of such image data include a window displaying scrollable content (e.g., a text, a picture, or an image), a window displaying various types of information requiring a confirmation (e.g., a menu), and a window displaying rotatable content (e.g., a picture or an image). If the image data displayed on the display unit 12 allows an operator to make an operation instruction more easily when the operator himself/herself is used as a reference, e.g., in a case of a screen related to replaying content, selection of a channel number, or the volume of sound output from the speakers 18A and 18B, the detection area setting module 312 is switched to the second mode.

The detection area setting module 312 then sets a plurality of detection areas to a piece of face image included in the video with reference to the position of the detected face image (S406). The detection areas herein mean areas from which an operator movement (a movement of an operator's hand giving an operation instruction, or a movement of an object caused by an operation instruction) for giving an operation instruction (e.g., to scroll the content displayed in the window, to confirm the various types of information displayed in the window, to rotate the content displayed in the window, to replay the content, to select a channel number, or to adjust the volume) is detected. When a plurality of face images are included in the video that is based on the acquired video data, the detection area setting module 312 sets a plurality of detection areas to each of the face images, with reference to the position of each of the face images.

In the embodiment, as illustrated in FIG. 5, the detection area setting module 312 detects a movement 506A and a movement 506B of hands 505 of an operator giving an operation instruction with reference to the position (X1, Y1) of the face image 502, and sets a plurality of detection areas 504A, 504B arranged along the x axis. Specifically, the detection area setting module 312 sets two detection area 504A, 504B plotted along an x-axis direction on both sides of the y axis that passes through the center (position coordinates (X1, Y1)) of the face image 502. These two detection areas 504A, 504B are arranged below the position coordinates (X1, Y1) of the face image 502 in the y-axis direction. In this manner, because the detection areas 504A, 504B are set with reference to the position of the operator, the detection areas 504A, 504B can be set at positions where the operator can understand easily. Furthermore, because complex information such as a process of informing the position of the detection areas 504A, 504B does not need to be informed to the operator, the cost required in informing the position of the detection areas 504A, 504B to the operator and a workload of the operator checking the position of the detection areas 504A, 504B can be reduced. Furthermore, because a plurality of detection areas 504A, 504B are set to a single piece of face image 502, an operator can make an increased number of operation instructions by making gestures (operator movements 506A, 506B giving operation instructions) in the respective detection areas 504A, 504B. For example, assuming that an operator can make top, bottom, right, and left gestures, that is, four different gestures in total, in a single detection area, 4ⁿ operation instructions can be made by combining gestures in “n” detection areas. Where, n is an integer equal to or more than 2.

More specifically, in the xy coordinate system having a point of origin at the position coordinates (X1, Y1) of the face image 502, the detection area setting module 312 acquires position coordinates (x1, y1) shifted downwardly from the position coordinates (X1, Y1) of the face image 502 (along the y-axis direction), as illustrated in FIG. 6. In other words, when the face image 502 of the operator is not inclined (when the upper torso of the operator is upright) as illustrated in FIG. 6, the detection area setting module 312 acquires the position coordinates (x1, y1) shifted from the position coordinates (X1, Y1) of the face image 502 by a predetermined amount (ΔX=0, ΔY) in the XY coordinate system. The detection area setting module 312 also detects the size r of the face image 502 (for example, a radius assuming that the face image 502 is a circle). The detection area setting module 312 then acquires, as the center positions of the respective detection areas 504A, 504B in the xy coordinate system, position coordinates (x2, y2) shifted from the position coordinates (x1, y1) to the negative side of the x axis by r·S1, and the position coordinates (x3, y3) shifted from the position coordinates (x1, y1) to the positive side of the x axis by r·S1. Where, S1 is a given value specified so that the two detection areas 504A, 504B are plotted interspaced from each other on both sides of the y axis. For example, S1 is a value specified so that the detection areas 504A, 504B are plotted at a distance between the hands of the operator of the computer 10 when the operator raises his/her hands at his/her shoulder width or about his/her elbows. The detection area setting module 312 then sets a rectangular area having two facing sides 504a each of which is separated from the position coordinates (x2, y2) in the x-axis direction by r·S3 and extending in parallel with the y axis, and having two facing sides 504b each of which is separated from the position coordinates (x2, y2) in the y-axis direction by r·S2 and extending in parallel with the x axis to the detection area 504A. The detection area setting module 312 also sets a rectangular area having two facing sides 504a each of which is separated from the position coordinates (x3, y3) in the x-axis direction by r·S3 and extending in parallel with the y axis, and having two facing sides 504b each of which is separated from the position coordinates (x3, y3) in the y-axis direction by r·S2 and extending in parallel with the x axis to the detection area 504B. Where, S2 and S3 are predetermined constants for making each of the detection areas 504A, 504B a rectangle area having a center at the position coordinates (x2, y2) and (x3, y3), respectively. In the embodiment, S1, S2, and S3 remains given values regardless who the operator operating the computer 10 is, but the embodiment is not limited thereto, and S1, S2, and S3 may be changed for a different operator of the computer 10.

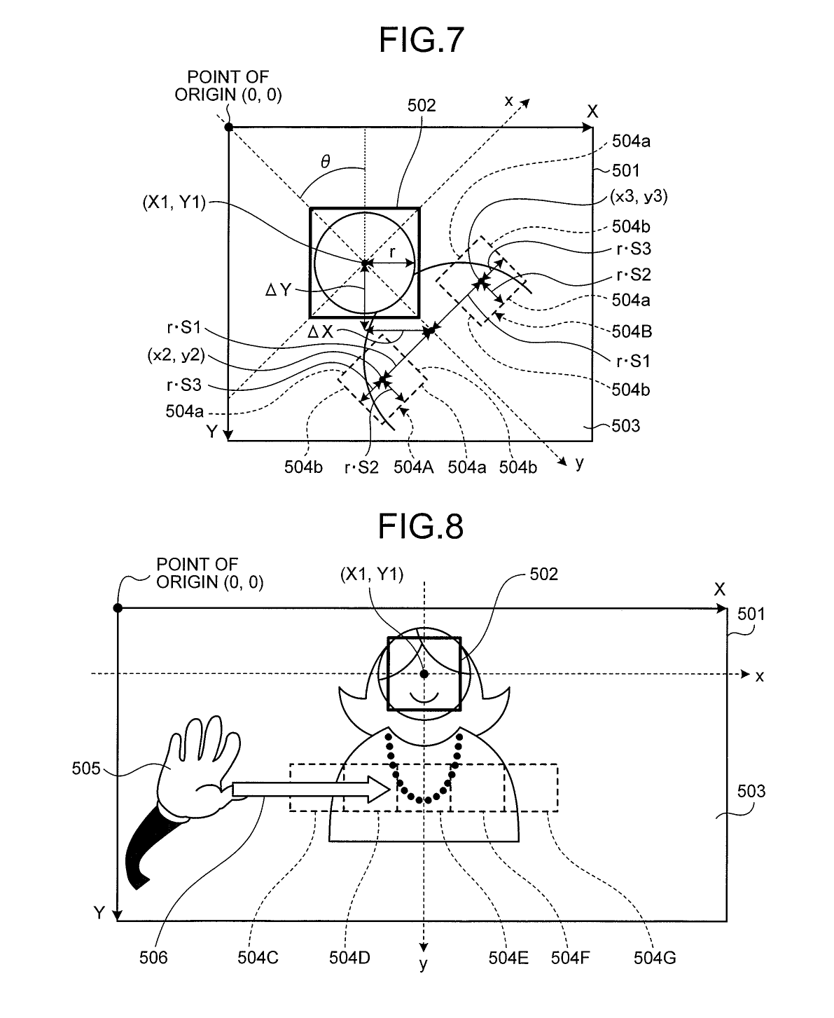

When the axis of the face image 502 (y axis) is inclined by an angle θ in the XY coordinate system as well, e.g., when the operator of the computer 10 is lying, the detection area setting module 312 sets the detection areas 504A, 504B in the same manner. As illustrated in FIG. 7, in the xy coordinate system having the point of origin at the position coordinates (X1, Y1) of the face image 502 and inclined by the angle θ with respect to the XY coordinate system, the detection area setting module 312 acquires the position coordinates (x1, y1) shifted downwardly from the position coordinates (X1, Y1) of the face image 502 (in the y-axis direction) being the center of the detection area 504. In other words, when the face image 502 of the operator is inclined by an angle θ, as illustrated in FIG. 7, the detection area setting module 312 acquires the position coordinates (x1, y1) shifted from the position coordinates (X1, Y1) of the face image 502 by an amount (ΔX, ΔY) that is predetermined for each angle θ, in the XY coordinate system. The detection area setting module 312 also detects the size r of the face image 502. The detection area setting module 312 then acquires, in the xy coordinate system, the position coordinates (x2, y2) that are separated from the position coordinates (x1, y1) by r·S1 in the negative side of the x axis, and position coordinates (x3, y3) that are separated from the position coordinates (x1, y1) by r·S1 in the positive side of the x axis, as the centers of the respective detection area 504A, 504B. The detection area setting module 312 then sets a rectangular area having two facing sides 504a each of which is separated from the position coordinates (x2, y2) in the x-axis direction by r·S3 and extending in parallel with the y axis, and having two facing sides 504b each of which is separated from the position coordinates (x2, y2) in the y-axis direction by r·S2 and extending in parallel with the x axis to the detection area 504A. The detection area setting module 312 also sets a rectangular area having two facing sides 504a each of which is separated from the position coordinates (x3, y3) in the x-axis direction by r·S3 and extending in parallel with the y axis, and having two facing sides 504b each of which is separated from the position coordinates (x3, y3) in the y-axis direction by r·S2 and extending in parallel with the x axis to the detection area 504B. In the manner described above, when the face image 502 is inclined by an angle θ in the XY coordinate system, e.g., when the operator is lying, for example, the detection area setting module 312 sets a given area located below the face image 502 in the y-axis direction to each of the detection areas 504A, 504B in the xy coordinate system that is inclined by the angle θ with respect to the XY coordinate system. Therefore, even when the operator is lying, for example, the operator can still make an operation instruction using the same gesture as when the upper torso of the operator is positioned upright.

In the embodiment, the detection area setting module 312 sets a rectangular area to each of the detection areas 504A, 504B, but the shape is not limited thereto, provided that such an area is set with reference to the position of the face image 502. For example, the detection area setting module 312 may set an area curved in an arc shape as a detection area.

Furthermore, in the embodiment, the detection area setting module 312 sets the detection areas 504A, 504B arranged along the x axis on both sides of the y axis that passes through the center of the face image 502, but the embodiment is not limited thereto. For example, the detection area setting module 312 may set a plurality of detection areas 504C to 504G that are arranged in a line along the x axis, and enabled to detect an operator movement 506 for giving an operation instruction, as illustrated in FIG. 8. Furthermore, the detection area setting module 312 may change how the detection areas are arranged depending on which one of the first mode and the second mode is selected. For example, while the first mode is selected, the detection area setting module 312 may set the detection area 504A, 504B arranged along the x axis on both sides of the y axis passing through the center of the face image 502, as illustrated in FIG. 5. By contrast, while the second mode is selected, the detection area setting module 312 may set a plurality of detection areas 504C to 504G arranged in a line along the x axis, as illustrated in FIG. 8.

Referring back to FIG. 4, the movement detecting module 314 detects movements from the respective detection areas set by the detection area setting module 312 (S407). When the detection area setting module 312 sets the detection areas to each of a plurality of face images, the movement detecting module 314 detects movements in the respective detection areas that are set to each of the face images. In the embodiment, the movement detecting module 314 detects the movements 506 of the hands 505 in the respective detection areas 504A, 504B in the frame image 501 included in the video that is based on the video data acquired by the image acquiring module 301, as illustrated in FIG. 5. The movement detecting module 314 also detects the movements 506A, 506B in the detection areas 504A, 504B using the mode selected by the detection area setting module 312 (the first mode or the second mode)

Specifically, the movement detecting module 314 extracts frame images 501 between time t at which the last frame image is captured and time t−1 preceding the time t by given time (e.g., time corresponding to 10 frames), from frame images 501 included in the video that is based on the acquired video data.

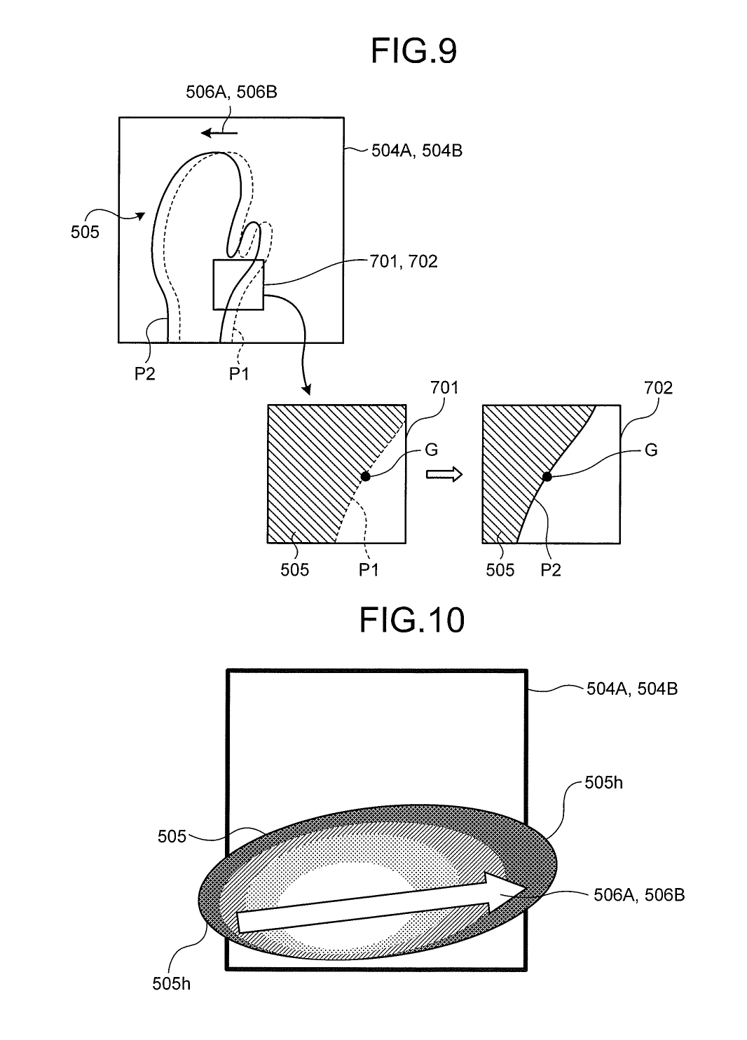

The movement detecting module 314 then detects the movements 506A, 506B of the hands 505 from the respective detection areas 504A, 504B in each of the extracted frame images 501. In the example illustrated in FIG. 9, the hand 505 included in the detection area 504A, 504B moves from a position P1 illustrated in a dotted line to a position P2 illustrated in a solid line between the time t−1 and the time t. Specifically, the movement detecting module 314 extracts at least one partial image 701 including the hand 505 included in the detection area 504A, 504B at the time t, and at least one partial image 702 including the hand 505 included in the detection area 504A, 504B at the time t−1. The movement detecting module 314 then detects a movement of at least one pixel G included in the hand 505 in the respective partial images 701 and 702 between the time t and the time t−1 as a movement 506A, 506B of the hand 505. When the first mode is selected by the detection area setting module 312, the movement detecting module 314 detects the movement of the pixel G with reference to the XY coordinate system. When the second mode is selected by the detection area setting module 312, the movement detecting module 314 detects the movement of the pixel G with reference to the xy coordinate system.

In the embodiment, the movement detecting module 314 detects the movement 506A, 506B of the hand 505 in the example illustrated in FIG. 9. However, the embodiment is not limited thereto, provided that an operator movement giving an operation instruction is detected by the movement detecting module 314. For example, the movement detecting module 314 may detect a movement of an object caused by an operation instruction given an operator (e.g., an object held in a hand of the operator). Furthermore, when the detection area setting module 312 sets the detection areas to each of a plurality of face images, the movement detecting module 314 detects movements in the respective detection areas set to each of the face images.

The movement detecting module 314 may also detect the movement 506A, 506B of the hand 505h near the detection area 504A, 504B, in addition to a movement 506A, 506B of the hand 505 in the detection area 504A, 504B, as illustrated in FIG. 10, provided that only the movement 506A, 506B detected in the detection area 504A, 504B is used in determining an operation instruction of the operator based on the movement 506A, 506B thus detected.

Among the movements 506A, 506B in the respective detection areas 504A, 504B, the movement detecting module 314 may detect only movements 506A, 506B that can be detected reliably, without detecting a movement at a speed higher than a predetermined speed or a movement not intended to be an operation instruction (in the embodiment, a movement of the hand 505 along the X axis or the Y axis, or a movement other than a movement of the hand 505 along the x axis or the y axis). In this manner, a movement of an operation instruction can be detected reliably.

Referring back to FIG. 4, the history acquiring module 315 acquires a history of movements detected from the respective detection areas by the movement detecting module 314 (S408).

The prohibition determining module 313 then determines if a prohibition period during which an operation instruction is prohibited has elapsed from when operation data is last output from the operation determining module 303 (S409). The prohibition period herein is a period during which an operator is prohibited from making any operation instruction, and may be set at discretion of an operator of the computer 10. If the prohibition period has not elapsed (No at S409), the prohibition determining module 313 waits until the prohibition period elapses. In this manner, when an operator makes an operation instruction and another operator makes an operation immediately after the first operator, the operation instruction made by the first operator is prevented from being cancelled by the operation instruction made by the second operator. Furthermore, when an operator makes an operation instruction using the same movement repeatedly (for example, when the operator repeatedly makes a movement of moving down the hand 505), as the hand 505 is brought back to the original position after moving down the hand 505, the movement of bringing back the hand 505 to the original position might be detected. In such a case, the prohibition period can prevent the movement of bringing down the hand 505 from being cancelled by the movement of bringing back the hand 505 to the original position.

The prohibition determining module 313 informs that an operation instruction can now be made after the prohibition period has elapsed. In the embodiment, when an operation instruction can be made, the prohibition determining module 313 notifies that an operation instruction can now be made by changing the display mode of the display unit 12, such as by displaying a message indicating that an operation instruction can now be made on the display unit 12. In the embodiment, the prohibition determining module 313 informs that an operation instruction can now be made by changing the display mode of the display unit 12, but the embodiment is not limited thereto, and the prohibition determining module 313 may also inform that an operation instruction can now be made using a light-emitting diode (LED) indicator not illustrated or the speakers 18A and 18B, for example.

When the prohibition determining module 313 determines that the prohibition period has elapsed (Yes at S409), the operation determining module 303 outputs operation data indicating an operation instruction that is based on a combination of the movements detected from the respective detection areas, from the history of movements acquired by the history acquiring module 315 (S410). Specifically, the operation determining module 303 outputs operation data indicating an operation instruction that is based on directions of the movement detected in the respective detection areas set to a piece of face image. The operation determining module 303 also outputs operation data indicating an operation instruction that is based on the number of detection areas from which the movements are detected, among the detection areas set to a piece of face image. In the embodiment, when the movements 506A, 506B detected in the detection areas 504A, 504B and acquired by the history acquiring module 315 are movements in a vertical direction or a horizontal direction in the XY coordinate system (or in the xy coordinate system), the operation determining module 303 outputs operation data indicating an operation instruction that is based on a combination of the movements 506A, 506B detected in the respective detection areas 504A, 504B and acquired by the history acquiring module 315.

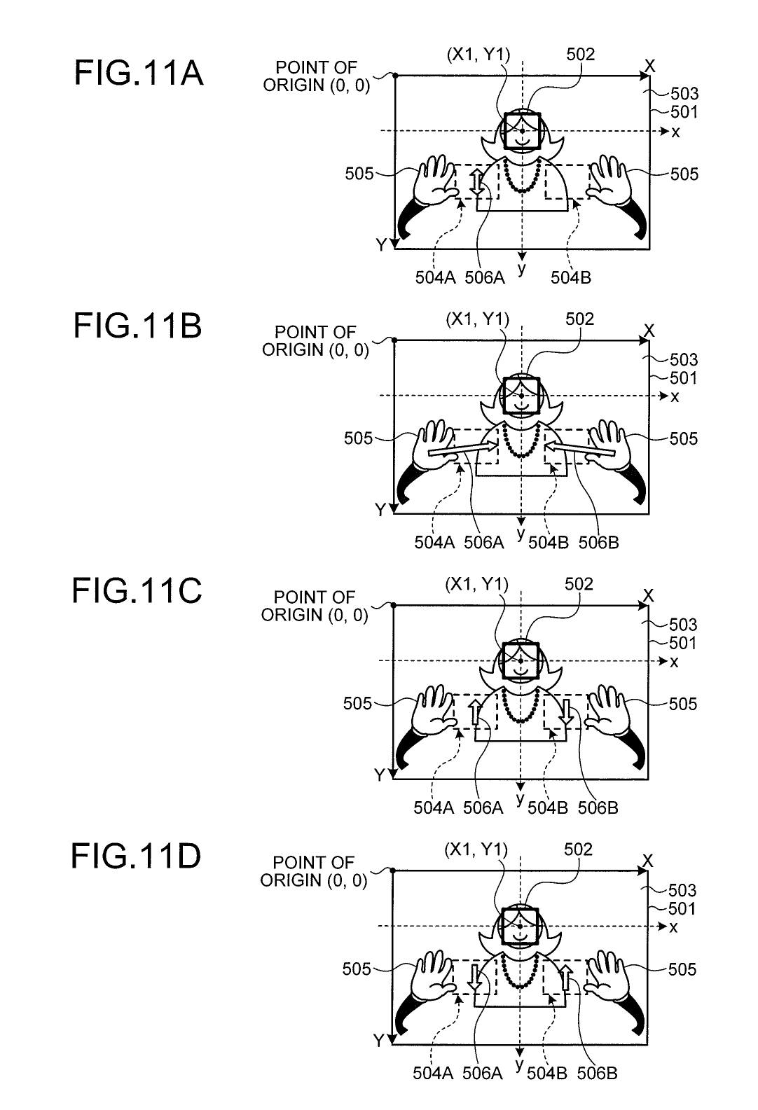

For example, when a window displaying scrollable content is displayed on the display unit 12 and the movement detecting module 314 detects a movement 506A (or a movement 506B) of the hand 505 along Y axis in the detection area 504A (or in the detection area 504B) as illustrated in FIG. 11A while the first mode is selected, the operation determining module 303 outputs operation data indicating to scroll the content.

When a window displaying various types of information requiring a confirmation is displayed on the display unit 12 and the movement detecting module 314 detects movements 506A, 506B of bringing the hands 505 together along the X axis in the respective detection areas 504A, 504B as illustrated in FIG. 11B while the first mode is selected, the operation determining module 303 outputs operation data indicating a process of confirming the various types of information.

When a window displaying rotatable content is displayed on the display unit 12 and the movement detecting module 314 detects a movement 506A of bringing up the hand 505 along the Y axis in the detection area 504A and detects a movement 506B of bringing down the hand 505 in the detection area 504B as illustrated in FIG. 11C while the first mode is selected, the operation determining module 303 outputs operation data indicating to rotate the rotatable content in the clockwise direction. When the movement detecting module 314 detects a movement 506A of bringing down the hand 505 along the Y axis in the detection area 504A, and detects a movement 506B of bringing up the hand 505 in the detection area 504B, as illustrated in FIG. 11D, the operation determining module 303 outputs operation data indicating to rotate the rotatable content in the counterclockwise direction.

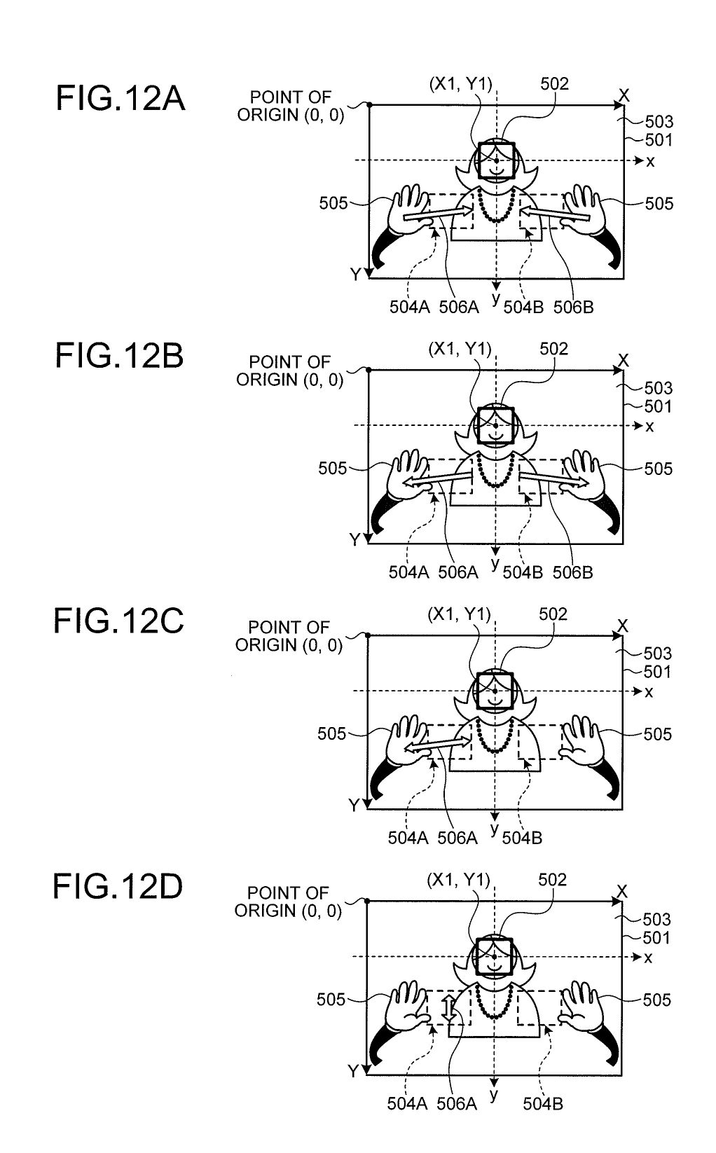

When a screen displaying content having replayed on the display unit 12 and the movement detecting module 314 detects movements 506A, 506B of bringing the hands 505 together along the x axis as illustrated in FIG. 12A while the second mode is selected, the operation determining module 303 outputs operation data indicating to replay the content. By contrast, when the movement detecting module 314 detects movements 506A, 506B of separating the hands 505 along the x axis, as illustrated in FIG. 12B, the operation determining module 303 outputs operation data indicating to stop replaying the content.

When a screen related to a channel number selection is displayed on the display unit 12 and the movement detecting module 314 detects a movement 506A (or a movement 506B) of the hand 505 along the x axis in the detection area 504A (or in the detection area 504B) as illustrated in FIG. 12C while the second mode is selected, the operation determining module 303 outputs operation data indicating to increase or to decrease the channel number.

When a screen related to the volume of sound output from the speakers 18A and 18B is displayed on the display unit 12 and the movement detecting module 314 detects a movement 506A (or a movement 506B) of the hand 505 along the Y axis in the detection area 504A (or in the detection area 504B) as illustrated in FIG. 12D while the second mode is selected, the operation determining module 303 outputs operation data indicating to increase or to reduce the volume.

When a screen related to the volume of sound output from the speakers 18A and 18B is displayed on the display unit 12 while the second mode is selected and the detection areas 504C to 504G are set as illustrated in FIG. 8, the operation determining module 303 outputs operation data indicating to increase or to reduce the volume correspondingly to the number of the detection areas from which the movement 506 is detected, among all of the detection areas 504C to 504G illustrated in FIG. 8.

In the manner described above, the computer 10 according to the embodiment sets a plurality of detection areas to a single piece of face image with reference to the position of a face image included in a video that is based on input video data, detects operator movements giving an operation instruction in the respective detection areas, and outputs operation data indicating an operation instruction that is based on a combination of the movements detected in the respective detection area. Therefore, an operation instruction can be given by a combination of a plurality of gestures, so that an increased number of operation instructions become possible.

The computer program executed on the computer 10 according to the embodiment may be provided in a manner recorded in a computer-readable recording medium such as a compact disk read-only memory (CD-ROM), a flexible disk (FD), a compact disk recordable (CD-R), or a digital versatile disk (DVD) as a file in an installable or executable format.

Furthermore, the computer program executed on the computer 10 according to the embodiment may be stored in a computer connected to a network such as the Internet, and made available for download over the network. Furthermore, the computer program executed on the computer 10 according to the embodiment may be provided or distributed over a network such as the Internet.

Furthermore, the computer program according to the embodiment may be provided in a manner incorporated in a ROM or the like in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a detector configured to set a plurality of detection areas to a single piece of face image included in a video image that is based on input video data, with reference to a position of the face image to detect movements of an operator giving an operation instruction in the detection areas; and
an output module configured to output operation data indicating the operation instruction based on a combination of the movements detected in the detection areas.

2. The information processing apparatus of claim 1, wherein the detection areas are arranged along a direction of a second axis perpendicularly intersecting with a first axis that extends in a vertical direction of the face image.

3. The information processing apparatus of claim 2, wherein
the first axis passes through center of the face image, and
the detection areas are arranged along the direction of the second axis on both sides of the first axis.

4. The information processing apparatus of claim 3, wherein the detection areas are arranged to be adjacent to each other in a line along the direction of the second axis.

5. The information processing apparatus of claim 1, wherein the output module is configured to output the operation data indicating the operation instruction based on directions of the movements detected in the detection areas.

6. The information processing apparatus of claim 1, wherein the output module is configured to output the operation data indicating the operation instruction based on the number of the detection areas in which the movements are detected.

7. The information processing apparatus of claim 2, wherein the detection areas are located below a position of the face image in a direction of the first axis.

8. An information processing method implemented by an information processing apparatus including a detector and an output module, the information processing method comprising:
setting, by the detector, a plurality of detection areas to a single piece of face image included in a video image that is based on input video data, with reference to a position of the face image to detect movements of an operator giving an operation instruction in the detection areas; and
outputting, by the output module, operation data indicating the operation instruction based on a combination of the movements detected in the detection areas.

9. A computer program product having a non-transitory computer readable medium including programmed instructions, wherein the instructions, when executed by a computer, cause the computer to perform:
setting a plurality of detection areas to a single piece of face image included in a video image that is based on input video data, with reference to a position of the face image to detect movements of an operator giving an operation instruction in the detection areas; and
outputting operation data indicating the operation instruction based on a combination of the movements detected in the detection areas.
